(19) United States
(12) Patent Application Publication
(10) Pub. No.: US 2023/0290932 A1
(43) Pub. Date: Sep. 14, 2023

(54) Positive Electrode Active Material, Positive Electrode and Method of Producing The Same, and Lithium-Ion Battery

(71) Applicant: Prime Planet Energy & Solutions, Inc., Tokyo (JP)

(72) Inventors: Keiichi TAKAHASHI, Nishinomiya-shi (JP); Ryo HANAZAKI, Kobe-shi (JP)

(21) Appl. No.: 18/179,371

(22) Filed: Mar. 7, 2023

(30) Foreign Application Priority Data
Mar. 10, 2022 (JP) 2022-036836

(51) Int. Cl. H01M 4/36; H01M 4/505; H01M 4/525; H01M 4/131; H01M 4/1391; H01M 4/04

(52) U.S. Cl. CPC H01M 4/364; H01M 4/505; H01M 4/525; H01M 4/131; H01M 4/1391; H01M 4/0404; H01M 4/366; H01M 2004/028

(57) ABSTRACT

The present disclosure relates to a positive electrode active material comprising a single particle and an aggregated particle formed of primary particles aggregated to each other, wherein the single particle includes a boron-containing compound or a tungsten-containing compound in a surface thereof, the single particle has a sphere degree of 0.91 or more, the positive electrode active material has a fluidity index (F. I) of 3.25 or more measured by a powder layer shearing test, and a mass ratio between the single particle and the aggregated particle is from 20:80 to 60:40. According to the present disclosure, a non-aqueous electrolyte secondary battery with reduced gas generation during high-temperature storage is provided.

This nonprovisional application is based on Japanese Patent Application No. 2022-036836 filed on Mar. 10, 2022, with the Japan Patent Office, the entire contents of which are hereby incorporated by reference.

### BACKGROUND OF THE INVENTION

### Field of the Invention

The present disclosure relates to a positive electrode active material, and it also relates to a positive electrode and a lithium-ion battery.

### Description of the Background Art

Japanese Patent Laying-Open No. 2017-084628 describes coating the surface of primary particles of a positive electrode active material, which is made of secondary particles having internal pores, with a lithium tungsten compound and WO₃.

### SUMMARY OF THE INVENTION

For the purpose of reducing the resistance of a positive electrode of a battery to enhance output properties and thereby achieve a high energy density, it is effective to use a tungsten-doped lithium-nickel composite oxide which has an increased particle size of lithium-nickel composite oxide particles and which also has an increased size of pores inside the lithium-nickel composite oxide particle relative to the cross-sectional area of the particle. However, the lithium tungsten compound tends to be segregated at primary particle grain boundaries due to a mismatch in the lattice constant, potentially leading to an increase of specific surface area to cause gas generation. Researches are underway to enhance packing properties by mixing aggregated particles and single particles together as a positive electrode active material, but the single particles tend to serve as a starting point for breakage of the aggregated particles.

An object of the present disclosure is to provide a non-aqueous electrolyte secondary battery with reduced gas generation during high-temperature storage.

The present disclosure provides a positive electrode active material, a positive electrode and a method of producing the same, and a lithium-ion battery, each of which is described below.

[1] A positive electrode active material comprising a single particle and an aggregated particle formed of primary particles aggregated to each other, wherein the single particle includes a boron-containing compound or a tungsten-containing compound in a surface thereof, the single particle has a sphere degree of 0.91 or more, the positive electrode active material has a fluidity index (F. I) of 3.25 or more measured by a powder layer shearing test, and a mass ratio between the single particle and the aggregated particle is from 20:80 to 60:40.

[2] The positive electrode active material according to [1], wherein the single particle includes a compound containing nickel, cobalt, and manganese, and has a ratio of nickel to metallic elements except lithium of 60 mol % or more, and the aggregated particle includes a compound containing nickel, cobalt, and manganese, and has a ratio of nickel to metallic elements except lithium of 70 mol % or more.

[3] The positive electrode active material according to [1] or [2], wherein the boron-containing compound is lithium borate, and the tungsten-containing compound is lithium tungstate.

[4] The positive electrode active material according to any one of [1] to [3], wherein the fluidity index (F. I) is from 3.25 to 8.0.

[5] A positive electrode comprising:
a positive electrode active material layer including the positive electrode active material according to any one of [1] to [4]; and
a base material.

[6] A lithium-ion battery comprising the positive electrode according to [5].

[7] A method of producing a positive electrode, the method comprising: preparing a positive electrode slurry including the positive electrode active material according to [1], applying the positive electrode slurry to a surface of a positive electrode base material to form a positive electrode active material layer, and rolling the positive electrode active material layer and the positive electrode base material to produce a positive electrode.

[8] The method of producing a positive electrode according to [7], further comprising covering a surface of a parent material with a boron-containing compound or a tungsten-containing compound to adjust a sphere diameter degree to obtain the single particle.

The foregoing and other objects, features, aspects and advantages of this disclosure will become more apparent from the following detailed description of this disclosure when taken in conjunction with the accompanying drawings.

### BRIEF DESCRIPTION OF THE DRAWINGS

FIG. 1 is a first descriptive view of a powder layer shearing test.

FIG. 2 is a second descriptive view of a powder layer shearing test.

FIG. 3 is a schematic view of an example of a lithium-ion battery according to the present embodiment.

FIG. 4 is a schematic view of an example of an electrode assembly according to the present embodiment.

FIG. 5 is a conceptual view of a positive electrode according to the present embodiment.

FIG. 6 is a schematic flowchart of a method of producing a positive electrode according to the present embodiment.

### DESCRIPTION OF THE PREFERRED EMBODIMENTS

In the following, an embodiment of the present disclosure (hereinafter also called “the present embodiment”) will be described. It should be noted that the below description does not limit the scope of claims.

<Positive Electrode Active Material>

A positive electrode active material includes a single particle and an aggregated particle formed of primary particles aggregated to each other. The positive electrode active material may consist essentially of a single particle and an aggregated particle. The positive electrode active material according to the present embodiment may be for a lithium-ion battery. The details of a lithium-ion battery will be described below.

The single particle and the aggregated particle may have any size. The average particle size D50 of the single particle may be, for example, from 1 μm to 20 μm, preferably from 1 μm to 10 μm, more preferably from 1 μm to 5 μm. Each of the average particle sizes D50, D70, D30 of the aggregated particle may be, for example, from 1 μm to 40 μm, preferably from 1 μm to 30 μm, more preferably from 1 μm to 20 μm. The average particle sizes D50, D70, D30 refer to particle sizes in volume-based particle size distribution at which the cumulative particle volume accumulated from the side of small particle sizes reaches 50%, 70%, 30%, respectively, of the total particle volume. The average particle size may be measured by a laser diffraction and scattering method.

The primary particle refers to a particle whose grain boundary cannot be visually identified in an SEM image of the particle, and this particle has an average primary particle size less than 0.5 μm. The average primary particle size refers to a distance between two points located farthest apart from each other on an outline of the primary particle. The average primary particle size of the primary particle may be from 0.05 μm to 0.2 μm or may be from 0.1 μm to 0.2 μm, for example. When each of 10 or more primary particles randomly selected from an SEM image of a single aggregated particle has an average primary particle size from 0.05 μm to 0.2 μm, it is regarded that each of all the primary particles included in this aggregated particle has an average primary particle size from 0.05 μm to 0.2 μm. The primary particle may have an average primary particle size from 0.1 μm to 0.2 μm, for example.

The single particle and the aggregated particle (primary particles) may include a compound containing nickel, cobalt, and manganese. The ratio of nickel to metallic elements except lithium in the single particle and the aggregated particle (primary particles) may be 60 mol % or more and 70 mol % or more, respectively, preferably 70 mol % or more and 80 mol % or more, respectively. The compound containing nickel, cobalt, and manganese preferably includes a nickel-cobalt-manganese composite hydroxide, more preferably a lithium-nickel-cobalt-manganese composite oxide. For example, the nickel-cobalt-manganese composite hydroxide may be obtained by coprecipitation and/or the like. For example, the nickel-cobalt-manganese composite hydroxide may be a compound represented by the following general formula: NiₓCo_{y}Mn_{z}(OH)₂ (where x+y+z=1). In the lithium-nickel-cobalt-manganese composite oxide, the molar ratio between lithium and a combination of nickel, cobalt, and manganese (namely, Li:(Ni+Co+Mn)) may be from 1.0 to 1.2:1.0, for example.

The single particle may include a first layered metal oxide, for example. The first layered metal oxide is represented by the following formula (1):

Li₁₋ₐ₁Niₓ₁Me¹₁₋ₓ₁O₂ (1)

where
“a1” satisfies a relationship of “−0.3≤a1≤0.3”,
“x1” satisfies a relationship of 0.61≤x<1.0, and
“Me¹” represents at least one selected from the group consisting of Co, Mn, Al, Zr, Ti, V, Cr, Fe, Cu, Zn, Mo, Sn, Ge, Nb, and W.

The primary particle may include a second layered metal oxide, for example.

The second layered metal oxide is represented by the following formula (2):

Li₁₋ₐ₂Niₓ₂Me²₁₋ₓ₂O₂ (2)

where
“a2” satisfies a relationship of “−0.3≤a2≤0.3”,
“x2” satisfies a relationship of 0.7≤x2≤1.0, and
“Me²” represents at least one selected from the group consisting of Co, Mn, Al,
Zr Ti, V, Cr, Fe, Cu, Zn, Mo, Sn, Ge, Nb, and W.

In the formulae (1) and (2), the relationship “x1<x2” may be satisfied, for example.

For example, the single particle may include at least one selected from the group consisting of LiNi_{0.8}Co_{0.1}Mn_{0.1}O₂, LiNi_{0.7}Co_{0.2}Mn_{0.1}O₂, LiNi_{0.7}Co_{0.1}Mn_{0.2}O₂, LiNi_{0.6}Co_{0.3}Mn_{0.1}O₂, LiNi_{0.6}Co_{0.2}Mn_{0.2}O₂, and LiNi_{0.6}Co_{0.1}Mn_{0.302}. For example, the primary particle may include at least one selected from the group consisting of LiNi_{0.8}Co_{0.1}Mn_{0.1}O₂, LiNi_{0.7}Co_{0.2}Mn_{0.1}O₂, and LiNi_{0.7}Co_{0.1}Mn_{0.2}O₂.

For example, both the single particle and the primary particle may consist essentially of LiNi_{0.8}Co_{0.1}Mn_{0.1}O₂. For example, both the single particle and the primary particle may consist essentially of LiNi_{0.7}Co_{0.2}Mn_{0.1}O₂. For example, the single particle may consist essentially of LiNi_{0.6}Co_{0.2}Mn_{0.2}O₂ and the primary particle may consist essentially of LiNi_{0.7}Co_{0.2}Mn_{0.1}O₂. For example, the single particle may consist essentially of LiNi_{0.6}Co_{0.2}Mn_{0.2}O₂ and the primary particle may consist essentially of LiNi_{0.8}Co_{0.1}Mn_{0.1}O₂.

When the aggregated particle is a lithium-nickel-cobalt-manganese composite oxide, a lithium-nickel-cobalt-manganese composite oxide having an aggregated structure may be obtained by, for example, mixing a lithium source such as lithium hydroxide with a nickel-cobalt-manganese composite hydroxide, calcining the mixture to obtain a lithium-nickel-cobalt-manganese composite oxide having an aggregated structure, and adding thereto a metal oxide, followed by heat treatment. The single particle may be obtained by, for example, dry grinding the lithium-nickel-cobalt-manganese composite oxide having an aggregated structure with the use of a jet mill and/or the like to dry it.

The single particle includes a boron-containing compound or a tungsten-containing compound in a surface thereof. From the viewpoint of sphere degree, the surface of the single particle is preferably covered with a boron-containing compound or a tungsten-containing compound. Preferably, the boron-containing compound is lithium borate. Preferably, the tungsten-containing compound is lithium tungstate. The boron-containing compound or the tungsten-containing compound included in the surface of the single particle may be, for example, from 0.1 mass % to 2.0 mass %, preferably from 0.2 mass % to 1.0 mass %, relative to the mass of the single particle.

Examples of the method for covering the surface of the single particle with a boron-containing compound or a tungsten-containing compound include mechanochemical treatment and the like. The mechanochemical treatment may be a treatment that involves subjecting a parent material (particles made of lithium-nickel-cobalt-manganese composite oxide) and a covering particle (boron or tungstic acid) to high-speed rotation together with a medium (ZrO₂ beads) inside a vessel, for example in a dry mode, to crush and bond the covering particle to the surface of the parent material for covering. The ratio of the covering particle to the parent material may be from 0.1 at % to 2.0 at % or less, for example.

The sphere degree of the single particle is 0.91 or more, preferably 0.92 or more, more preferably 0.93 or more, and, for example, may be 1.00 or less, or may be 0.99 or less. The sphere degree of the single particle is determined by a method described below in the Examples section. When the sphere degree of the single particle is within the above range, packing properties tend to be enhanced. The sphere degree of the single particle may be adjusted by adjusting the conditions of the mechanochemical treatment described above, for example.

The positive electrode active material has a fluidity index (F. I) measured by a powder layer shearing test of 3.25 or more, and from the viewpoint of packing properties, it is preferably 3.5 or more, more preferably 4 or more, and may be 8.0 or less, for example. Examples of the method for adjusting the fluidity index (F. I) to the above range include selecting the types of the single particle and the aggregated particle, the sphere degree of the single particle, the average particle size and the mixing ratio of the single particle and the aggregated particle, and the like, and adjusting the mixing conditions. In the following, the method for measuring the fluidity index (F. I) is described.

FIG. 1 is a first descriptive view of a powder layer shearing test. A testing apparatus 200 comprises a servo cylinder 210, a first load cell 220, a sample cell 230, a second load cell 240, a linear actuator 250, and a third load cell 260. A measurement target is filled into sample cell 230. In this way, a powder layer 201 is formed. Sample cell 230 is cylindrical. Sample cell 230 includes an upper cell 231 and a lower cell 232. Sample cell 230 is separated into upper cell 231 and lower cell 232. Servo cylinder 210 applies a load to the powder in the vertical direction (in the z-axis direction). By this, normal stress is generated, which makes powder layer 201 compacted. Upper cell 231 is fixed. Linear actuator 250 moves lower cell 232 in the horizontal direction (in the x-axis direction). Thus, powder layer 201 shear-yields.

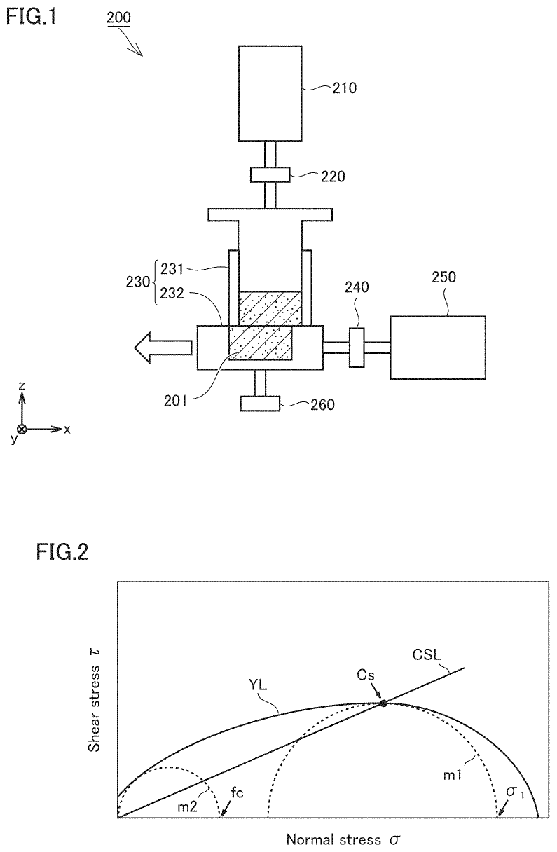

FIG. 2 is a second descriptive view of a powder layer shearing test. From the normal stress σ and the shear stress τ in the powder layer shearing test, unconfined yield stress f_{c} and maximum principal stress σ₁ are derived. In the rectangular coordinates of FIG. 2, normal stress σ is on the horizontal axis and shear stress τ is on the vertical axis. Firstly, a yield locus YL is drawn. While normal stress σ is applied to an arbitrary surface in powder layer 201, shear stress τ gradually acts on the surface in the horizontal direction. Due to the shear stress τ, the surface in powder layer 201 starts to yield. This state is a critical state of stress. The normal stress σ and the shear stress τ in the critical state of stress are plotted. In this way, a yield locus YL is drawn. Then, a critical state line CSL is drawn. After shear-yielding, shear stress τ changes temporarily, and then, after a while, it becomes constant. The shear stress τ that has become constant and the normal stress σ at this time are plotted. In this way, a critical state line CSL is drawn. The critical state line CSL is a straight line passing the origin. The point of intersection of the yield locus YL and the critical state line CSL is a critical state Cs. A Mohr's stress circle m1 passing the critical state Cs and being in contact with the yield locus YL is drawn. Among the points of intersection of the Mohr's stress circle m1 and the horizontal axis, one with a larger value is the maximum principal stress σ₁. A Mohr's stress circle m2 passing the origin and being in contact with the yield locus YL is drawn. The point of intersection of the Mohr's stress circle m2 and the horizontal axis (except the origin) is the unconfined yield stress f_{c}. The fluidity index (F. I) is determined from the value of ff_{c} calculated by the following expression: ff_{c}=σ₁/f_{c}.

The mass ratio between the single particle and the aggregated particle in the positive electrode active material is from 20:80 to 60:40, preferably from 30:70 to 50:50. When the mass ratio between the single particle and the aggregated particle in the positive electrode active material is within the above range, packing properties tend to be enhanced.

<Lithium-Ion Battery>

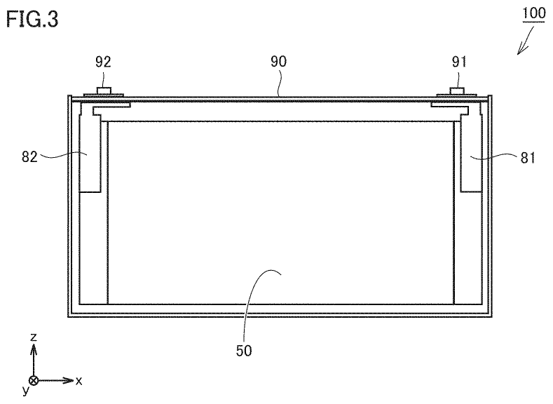

FIG. 3 is a schematic view of an example of a lithium-ion battery according to the present embodiment. A battery 100 shown in FIG. 3 may be, for example, a lithium-ion battery as a main electric power supply or a motive force assisting electric power supply of an electric vehicle.

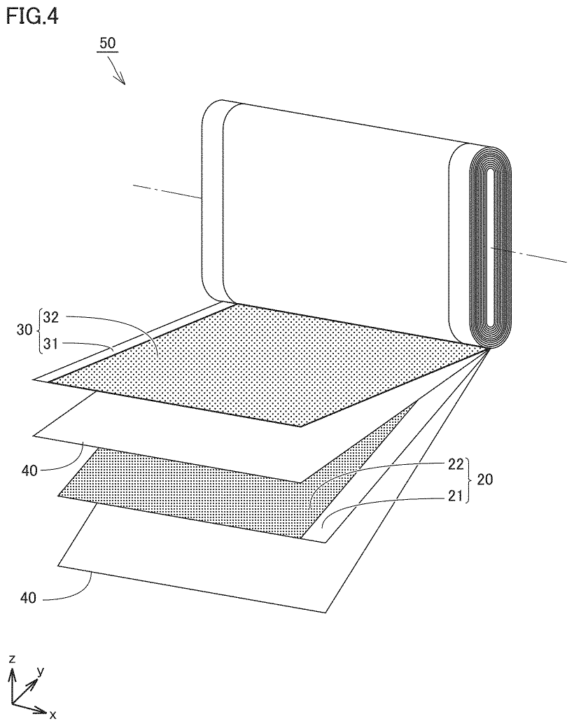

Battery 100 includes an exterior package 90. Exterior package 90 accommodates an electrode assembly 50 and an electrolyte (not illustrated). Electrode assembly 50 is connected to a positive electrode terminal 91 via a positive electrode current-collecting member 81. Electrode assembly 50 is connected to a negative electrode terminal 92 via a negative electrode current-collecting member 82. FIG. 4 is a schematic view of an example of an electrode assembly according to the present embodiment. Electrode assembly 50 is a wound-type one. Electrode assembly 50 includes a positive electrode 20, a separator 40, and a negative electrode 30. That is, battery 100 includes positive electrode 20. Positive electrode 20 includes a positive electrode active material layer 22 and a positive electrode base material 21. Negative electrode 30 includes a negative electrode active material layer 32 and a negative electrode base material 31.

<Positive Electrode>

Referring to FIG. 5, in positive electrode 20, positive electrode active material layer 22 may be formed directly or indirectly on one side or both sides of positive electrode base material 21. Positive electrode base material 21 may be a conductive sheet made of Al alloy foil, pure Al foil, and/or the like, for example. Positive electrode active material layer 22 includes a positive electrode active material including a single particle 11 and an aggregated particle 12. Positive electrode active material layer 22 may further include a conductive material, a binder, and/or the like.

Positive electrode active material layer 22 may have a thickness from 10 μm to 200 μm, for example. Positive electrode active material layer 22 may have a high density. The density of positive electrode active material layer 22 may be 3.7 g/cm³ or more, for example, or may be 3.8 g/cm³ or more or 3.9 g/cm³ or more. Positive electrode active material layer 22 may have a density of 4.0 g/cm³ or less, for example.

<Method of Producing Positive Electrode>

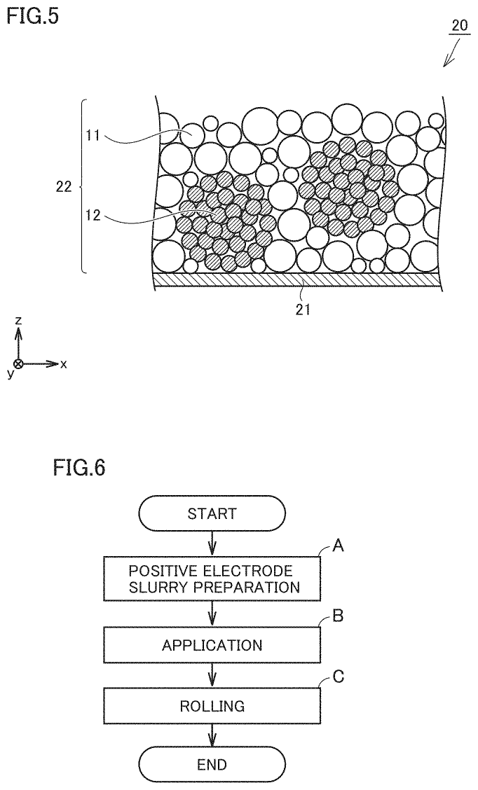

The method of producing positive electrode 20 according to the present embodiment comprises positive electrode slurry preparation (A), application (B), and rolling (C), as shown in FIG. 6.

In the positive electrode slurry preparation (A), a positive electrode slurry including the above-described positive electrode active materials is prepared. The positive electrode slurry is prepared by dispersing the positive electrode active material in a dispersion medium. The single particle and the aggregated particle may be independently synthesized by coprecipitation and/or the like, for example. The single particle and the aggregated particle are mixed so that the fluidity index (F. I) becomes 3.25 or more, for example. The single particle may be obtained by covering the surface of the parent material with a boron-containing compound or a tungsten-containing compound and adjusting the sphere diameter degree (the sphere degree). The adjustment of the sphere diameter degree (the sphere degree) is as described above.

In the application (B), the positive electrode slurry is applied to the surface of positive electrode base material 21 to form a positive electrode active material layer 22. In the rolling (C), positive electrode active material layer 22 and positive electrode base material 21 are rolled to produce a positive electrode 20. By the rolling, a raw sheet of positive electrode 20 is produced. The raw sheet may be cut into a predetermined planar size depending on the specifications of battery 100.

### EXAMPLES

In the following, the present disclosure will be described in further detail by way of Examples. “%” and “part(s)” in Examples refer to mass % and part(s) by mass, respectively, unless otherwise specified. The below description does not limit the scope of claims.

[Production of Single Particles Nos. 1 to 3]

Nickel-cobalt-manganese composite hydroxide with a composition of Ni_{0.80}Co_{0.10}Mn_{0.10}(OH)₂ obtained by coprecipitation was calcined at 500° C. to give nickel-cobalt-manganese composite oxide (Z1).

Then, lithium hydroxide and the nickel-cobalt-manganese composite oxide (Z1) were mixed together so that the molar ratio of Li to the total amount of Ni, Co, and Mn became 1.05:1, and the resulting mixture was calcined in an oxygen atmosphere at 850° C. for 72 hours, wet-ground in a ball mill, and dried to form a single particle structure, followed by another heat treatment in an oxygen atmosphere at 750° C. for 10 hours to give a lithium composite oxide A with a single particle structure.

The particle size distribution of the lithium composite oxide A was measured to give a particle size (D50) value of 3.3 μm, and, as a result of SEM examination of the structure, it was found that the composite oxide A was particles mostly with a single particle structure and with a particle size from 2.3 to 3.5 μm.

The active material particle having a single particle structure thus obtained, together with 1 at % boric acid and Φ-20-mm ZrO₂ beads, was placed in an agate vessel, and, with the use of a 2 h planetary ball mill apparatus (P5, manufactured by Fritsch Co., Ltd.), mechanochemical treatment was carried out. The duration of the mechanochemical treatment is shown in Table 1

[Production of Single Particle No. 4]

A single particle No. 4 was obtained in the same manner as in the production of single particles Nos. 1 to 3 except that tungstic acid was used in the mechanochemical treatment and the duration of the mechanochemical treatment was 1 hour.

[Sphere Degree]

A particle is randomly selected in an SEM photograph of the single particles, and the project area (A) and the circumference (M) of the particle are measured. A sphere having the circumference (M) thus measured has a radius (r) of M/2π and an area (B) of π×(M/2π)2. From the areas A and B thus measured and calculated, sphere degree (AB)=A×4π/M2 is calculated. The sphere degree was measured for 100 single particles, and the average value was defined as the sphere degree. The sphere degree is shown in Table 1.

[Production of Aggregated Particle]

Nickel-cobalt-manganese composite hydroxide with a composition of Ni_{0.80}Co_{0.10}Mn_{0.10}(OH)₂ obtained by coprecipitation was calcined with lithium hydroxide at 800° C. for 10 hours in an oxygen atmosphere, and then disintegrated in an agate mortar to give lithium composite oxide (B) with an aggregated particle structure.

As for the particle size distribution of the composite oxide B, D50 was 12 μm, D70 was 14 μm, and D30 was 10 μm. Checking a cross section of the composite oxide B by SEM examination after CP work treatment revealed that the average primary particle size of the composite oxide B was 0.13 μm.

[Method of Mixing Single Particle and Aggregated Particle]

The single particle and the aggregated particle in a mass ratio specified in Table 1 were placed in a tumbling fluidized drying apparatus and mixed uniformly to give a mixed positive electrode active material powder.

[Fluidity Index (F. I)]

A powder layer shearing test was carried out in accordance with “JIS Z8835: Direct shear testing method for critical state line (CSL) and wall yield locus (WYL) of powder bed”. ff_{c} was measured three times or more. The arithmetic mean of these three or more results was regarded as the ff_{c} of the measurement target. ff_{c} (average value) was significant to one decimal place, rounded to one decimal place.

[Production of Positive Electrode Plate]

The above mixed positive electrode active material powder, acetylene black, and polyvinylidene difluoride (PVdF) were mixed in a solid mass ratio of 96.3:2.5:1.2, followed by addition of a proper amount of N-methyl-2-pyrrolidone (NMP) and kneading to give a positive electrode composite material slurry. The resulting positive electrode composite material slurry was applied to both sides of an aluminum foil core No. 1C32 with a thickness of 13 μm and the resulting coating film was dried, followed by compression with a rolling mill to achieve a composite material density of the coating film of 3.7 g/cm³, and then cutting into a predetermined electrode size to give a positive electrode having a positive electrode composite material layer formed on both sides of the positive electrode core.

[Production of Small Lithium-Ion Battery]

The resultant was combined with a carbon negative electrode to give a small laminate-type battery designed to have 650 WH/L. Moreover, the particle structure and the composition of the positive electrode active material as well as the mixing ratio were changed and, thereby, batteries of Examples and Comparative Examples as shown in the Table were produced, and the amount of gas generation before and after 30 days of storage testing at 60° C. was determined from the volume change obtained by an Archimedes' method. Results are shown in Table 1.

TABLE 1

| | | | | | | Amount |
|---|---|---|---|---|---|---|
| | | | | | | of gas |
| | | | | | Fluidity | generation |
| | | | | Mass ratio of | index | after 30 days |
| | | Mechanochemical | | single particle and | F.I. (m) | of storage |
| | Single | treatment | | aggregated particle | of active | testing |
| | particle | duration | Sphere | ((single particle): | material | at 60° C. |
| | No. | (h) | degree | (aggregated particle)) | layer | (cm³/Ah) |
| Comp. Ex. 1 | — (None) | — (No treatment) | — | 0:100 | 1.29 | 3.6 |
| Comp. Ex. 2 | 1 | — (No treatment) | 0.87 | 30:70 | 3.46 | 2.8 |
| Comp. Ex. 3 | 2 | 1 | 0.95 | 75:25 | 4.31 | 3.1 |
| Ex. 1 | 2 | 1 | 0.95 | 20:80 | 3.25 | 2 |
| Ex. 2 | 2 | 1 | 0.95 | 50:50 | 3.52 | 1.9 |
| Comp. Ex. 4 | 1 | — (No treatment) | 0.87 | 50:50 | 5.07 | 2.5 |
| Ex. 3 | 3 | 0.5 | 0.91 | 50:50 | 5.5 | 1.8 |
| Ex. 4 | 2 | 1 | 0.95 | 30:70 | 4.86 | 1.7 |
| Ex. 5 | 2 | 1 | 0.95 | 60:40 | 4.57 | 1.6 |
| Ex. 6 | 4 | 1 | 0.94 | 60:40 | 3.62 | 1.9 |

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

The embodiments and examples disclosed herein are illustrative and non-restrictive in any respect. The technical scope indicated by the claims encompasses any modifications within the scope and meaning equivalent to the terms of the claims.

What is claimed is:

1. A positive electrode active material comprising:
a single particle; and
an aggregated particle formed of primary particles aggregated to each other, wherein
the single particle includes a boron-containing compound or a tungsten-containing compound in a surface thereof,
the single particle has a sphere degree of 0.91 or more,
the positive electrode active material has a fluidity index (F. I) of 3.25 or more measured by a powder layer shearing test, and
a mass ratio between the single particle and the aggregated particle is from 20:80 to 60:40.

2. The positive electrode active material according to claim 1, wherein
the single particle includes a compound containing nickel, cobalt, and manganese, and has a ratio of nickel to metallic elements except lithium of 60 mol % or more, and
the aggregated particle includes a compound containing nickel, cobalt, and manganese, and has a ratio of nickel to metallic elements except lithium of 70 mol % or more.

3. The positive electrode active material according to claim 1, wherein the boron-containing compound is lithium borate, and the tungsten-containing compound is lithium tungstate.

4. The positive electrode active material according to claim 2, wherein the boron-containing compound is lithium borate, and the tungsten-containing compound is lithium tungstate.

5. The positive electrode active material according to claim 1, wherein the fluidity index (F. I) is from 3.25 to 8.0.

6. A positive electrode comprising:
a positive electrode active material layer including the positive electrode active material according to claim 1; and
a base material.

7. A lithium-ion battery comprising the positive electrode according to claim 6.

8. A method of producing a positive electrode, the method comprising:
preparing a positive electrode slurry including the positive electrode active material according to claim 1;
applying the positive electrode slurry to a surface of a positive electrode base material to form a positive electrode active material layer; and
rolling the positive electrode active material layer and the positive electrode base material to produce a positive electrode.

9. The method of producing a positive electrode according to claim 8, further comprising covering a surface of a parent material with a boron-containing compound or a tungsten-containing compound to adjust a sphere diameter degree to obtain the single particle.
